(19) United States
(12) Patent Application Publication
(10) Pub. No.: US 2011/0070046 A1
(43) Pub. Date: Mar. 24, 2011

(54) METAL PLATE MEMBER FIXATION DEVICE

(76) Inventor: Kuo-Chung WANG, Yunlin County (TW)

(21) Appl. No.: 12/566,368

(22) Filed: Sep. 24, 2009

(51) Int. Cl. F16B 39/10

(52) U.S. Cl. 411/120

(57) ABSTRACT

A metal plate member fixation device includes a barrel for bonding to a mounting through hole of a first metal plate member, a lock screw bolt inserted through the barrel for threading into a screw hole of a second metal plate member to lock the first and second metal plate members together, a cap affixed to the head of the lock screw bolt for gripping, a spring member sleeved onto the shank of the lock screw bolt and stopped against the heat of the lock screw bolt, and a stop washer positioned in an annular inside locating groove in the barrel around the shank of the lock screw bolt and stopped against the other end of the spring member for allowing axial movement of the lock screw bolt relative to the barrel within a predetermined range and for stopping against one end of the thread of the lock screw bolt to prohibit escape of the lock screw bolt from the barrel.

### BACKGROUND OF THE INVENTION

1. Field of the Invention

The present invention relates to a metal plate member fixation device for joining two metal plate members and more particularly, to a low-profile metal plate member fixation device, which is formed of a locking device, a barrel, a spring member and a stop washer, wherein the stop washer secures the lock screw bolt of the locking device to the barrel, allowing axial movement of the lock screw bolt relative to the barrel within a predetermined range and prohibiting escape of the lock screw bolt from the barrel.

2. Description of the Related Art

When fastening two plate members together, a positioning screw formed of a knob, a ring and a screw nail is usually used. During installation, the screw nail and the ring are secured to the first plate member, and then the knob is rotated to drive the screw nail into the second plate member, and then a hand tool is used to fasten tight the screw nail, affixing the first and second plate members together. This plate member joining method can be used in a machine tool to join plate members together.

The power drive and speed-adjustment unit of a machine tool are generally provided inside the housing. To facilitate repair of a machine tool or adjustment of the output speed of a machine tool, a detachable plate member is usually provided at the housing of the power drive or speed-adjustment unit. Screw bolts are commonly used to fasten the movable plate member to the housing. When unfastening screw bolts to dismount a movable plate member from the housing, the associating lock nuts may fall from the screw bolts. This movable plate member mounting and dismounting procedure is complicated, wasting much time and labor.

There is known a metal plate member fixation device comprised of a cap, a screw bolt, a spring member and a locating base for joining two metal plate members together. After fixation of the locating base of the metal plate member fixation device to a through hole on a first plate member, the screw bolt is threaded into a screw hole on a second plate member to secure the first plate member and the second plate member together. Because the locating base of the metal plate member fixation device is kept secured to the first plate member after removal of the first plate member from the second plate member, the metal plate member fixation device will not be missed by accident. According to this design, the cap is a metal member. After the screw bolt is accommodated in the cap, a machine tool is used to process the cap so that retaining protrusions are formed on the cap and forced into engagement with the screw bolt. This processing process requires high precision and wastes time and labor. During processing, the cap may be compressed excessively, resulting in permanent deformation.

Therefore, it is desirable to provide a metal plate member fixation device that eliminates the aforesaid problems.

### SUMMARY OF THE INVENTION

The present invention has been accomplished under the circumstances in view. It is therefore an object of the present invention to provide a metal plate member fixation device for joining metal plate members, which facilitates installation and presents disconnection between component parts.

To achieve these and other objects of the present invention, a metal plate member fixation device comprises a barrel for bonding to a first metal plate member, a locking device, which comprises a lock screw bolt axially slidably coupled to the barrel for inserting through a mounting through hole on the first metal plate member and threading into a screw hole on a second metal plate member to lock the first metal plate member and the second metal plate member together and a cap affixed to the head of the lock screw bolt for gripping, a spring member sleeved onto the shank of the lock screw bolt inside the cap and stopped against the head of the lock screw bolt, and a stop washer set in an annular inside locating groove inside the barrel around the shank of the lock screw bolt and stopped against the other end of the spring member for stopping against one end of the thread of the lock screw bolt to prohibit escape of the lock screw bolt of the locking device from the barrel. By means of the application of the stop washer, the height (length) of the spring member can be minimized so that the metal plate member fixation device can have a low profile characteristic for easy, quick and accurate installation.

### BRIEF DESCRIPTION OF THE DRAWINGS

FIG. 1 is an elevational view of a metal plate member fixation device in accordance with the present invention.

FIG. 2 is an exploded view of the metal plate member fixation device in accordance with the present invention.

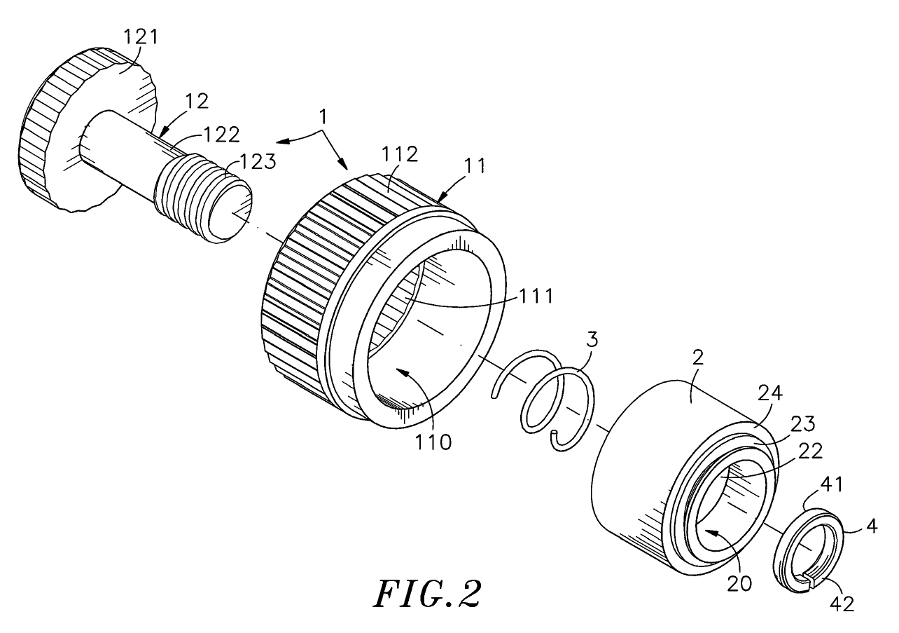

FIG. 3 is an exploded view in sectional elevation of the metal plate member fixation device in accordance with the present invention.

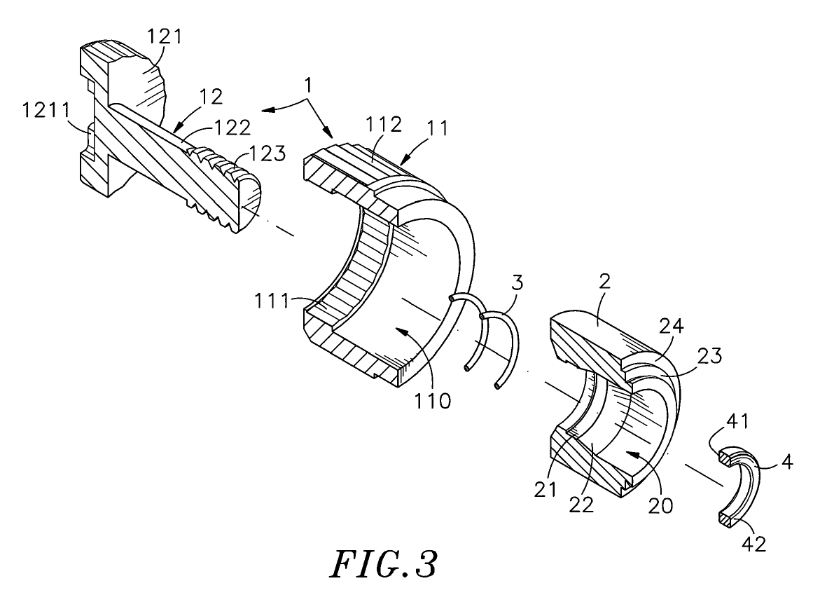

FIG. 4 is a sectional assembly view of the metal plate member fixation device in accordance with the present invention (I).

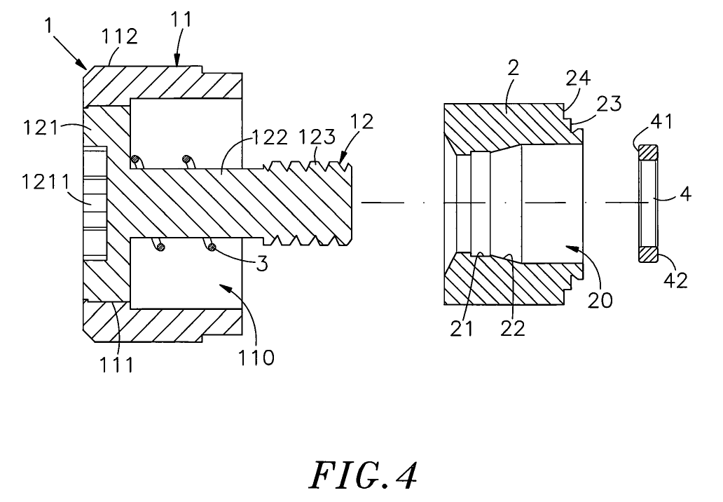

FIG. 5 is a sectional assembly view of the metal plate member fixation device in accordance with the present invention (II).

FIG. 6 is a sectional assembly view of the metal plate member fixation device in accordance with the present invention (III).

FIG. 7 is a schematic sectional applied view of the present invention, showing the barrel of the metal plate member fixation device bonded to a first metal plate member.

FIG. 8 corresponds to FIG. 7, showing the first metal plate member attached to the second metal plate member and the lock screw bolt of the locking device fastened to the screw hole of the second metal plate member.

### DETAILED DESCRIPTION OF THE PREFERRED EMBODIMENT

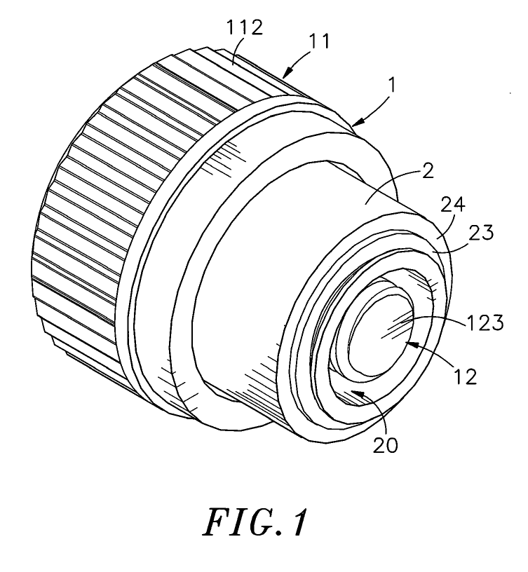

Referring to FIGS. 1˜4, a metal plate member fixation device in accordance with the present invention is shown comprising a locking device 1, a barrel 2, a spring member 3, and a stop washer 4.

The locking device 1 comprises a cap 11 and a lock screw bolt 12. The cap 11 is a hollow member having a center opening 110 axially extending through the top and bottom sides for receiving the barrel 2, the lock screw bolt 12 and the spring member 3, a mounting groove 111 extending around the inside wall thereof in one end of the center opening 110 and a grip 112 located on the periphery for gripping by hand. The lock screw bolt 12 is a metal screw bolt having a head 121 fitting the mounting groove 111 of the cap 11, a shank 122 perpendicularly extended from the center of the bottom wall of the head 121, a thread 123 spirally extending around the periphery of one end of the shank 122 remote from the head 121 and a tool groove 1211 located on the top wall of the head 121.

The barrel 2 is a hollow cylindrical metal member having a mounting hole 20 extending through top and bottom sides thereof for the passing of the shank 122 of the lock screw bolt 12, an annular inside locating groove 21 extending around the inside wall thereof near one end of the mounting hole 20, a sloping inside wall portion 22 gradually increasing in diameter in direction from the annular inside locating groove 21 toward the other end of the mounting hole 20, a bottom bonding wall 24 located on the bottom side around the mounting hole 20 and a bottom extension tube 23 perpendicularly extended from the bottom bonding wall 24 around the mounting hole 20.

The spring member 3 is sleeved onto the lock screw bolt 12, having one end thereof stopped against the head 121 of the lock screw bolt 12 and the other end thereof inserted into the mounting hole 20 of the barrel 2.

The stop washer 4 is inserted into the mounting hole 20 of the barrel 2 and engaged in the annular inside locating groove 21 of the barrel 2, having a top bearing surface 41 for supporting one end of the spring member 3 and a bottom stop surface 42 for stopping against one end of the thread 123 of the lock screw bolt 12 to prohibit escape of the lock screw bolt 12 from the barrel 2 after the metal plate member fixation device has been assembled.

The aforesaid lock screw bolt 12 is made of metal. The cap 11 can be directly molded on the head 121 of the lock screw bolt 12 with over-molding technology. Alternatively, the cap 11 can be separately made and then affixed to the lock screw bolt 12 by means of any of a variety of fastening techniques. In this case, male engagement means, such as barbs, threads or teeth, may be formed on the periphery of the head 121 of the lock screw bolt 12 for engagement with the mounting groove 111 of the cap 11. When the cap 11 and the lock screw bolt 12 are molded or fastened together, a user can drive the grip 112 to rotate the lock screw bolt 12 into the workpiece. The stop washer 4 can be made from brass, zinc alloy, aluminum or any other metal materials having high extensibility. Alternatively, a C-shaped retainer ring can be used to substitute for the stop washer 4.

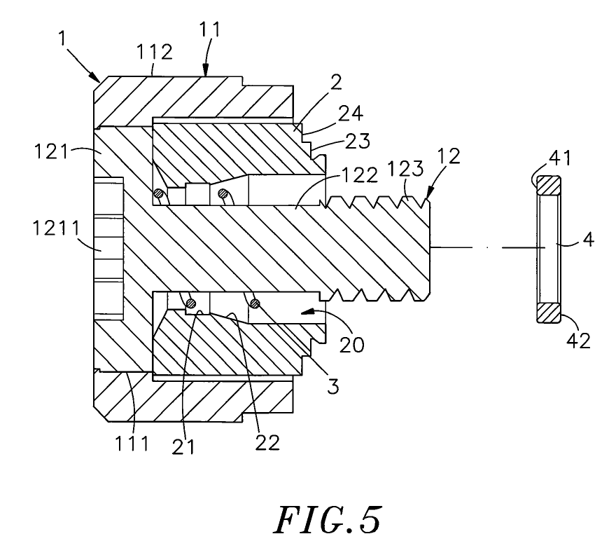

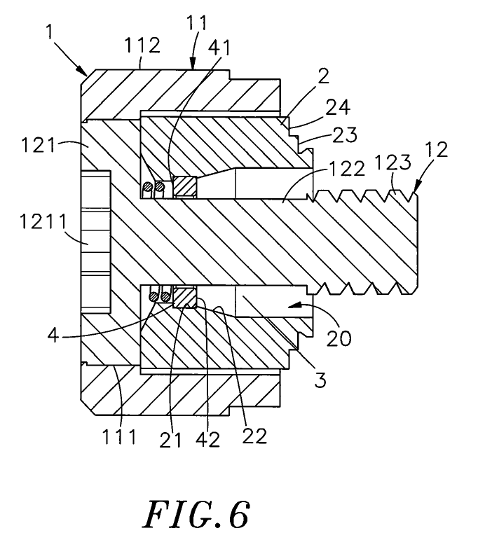

Referring to FIGS. 5 and 6 and FIGS. 1˜4 again, during assembly process of the metal plate member fixation device, sleeve the spring member 3 onto the shank 122 of the lock screw bolt 12 to have one end of the spring member 3 be stopped at the bottom side of the head 121 of the lock screw bolt 12, and then insert the barrel 2 into the center opening 110 of the cap 11 around the spring member 3 and the shank 122 of the barrel 2 against the other end of the spring member 3, and then use a tool to insert the stop washer 4 into the mounting hole 20 of the barrel 2 and to further force the stop washer 4 inwardly along the sloping inside wall portion 22 over the thread 123 of the lock screw bolt 12 against the spring member 3 into the annular inside locating groove 21 of the barrel 2. After the stop washer 4 has been positioned in the annular inside locating groove 21 of the barrel 2, the top bearing surface 41 of the stop washer 4 is stopped against one end of the spring member 3 and the bottom stop surface 42 of the stop washer 4 is stopped against one end of the thread 123 of the lock screw bolt 12 to prohibit escape of the lock screw bolt 12 from the barrel 2. Thus, the lock screw bolt 12 is axially movably coupled to the barrel 2 and the stop washer 4 for installation.

Further, when assembling the lock screw bolt 12 and the barrel 2, the spring member 3 is stopped against the stop washer 4 and the stop washer 4 is forced into the annular inside locating groove 21 of the barrel 2 for stopping against one end of the thread 123 of the lock screw bolt 12. By means of the application of the stop washer 4, the height (length) of the spring member 3 can be minimized so that the metal plate member fixation device can have a low profile characteristic for easy, quick and accurate installation.

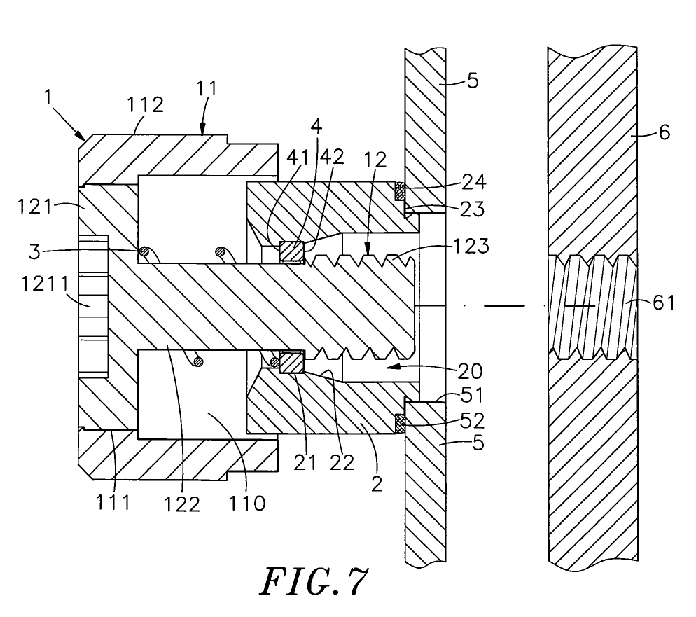

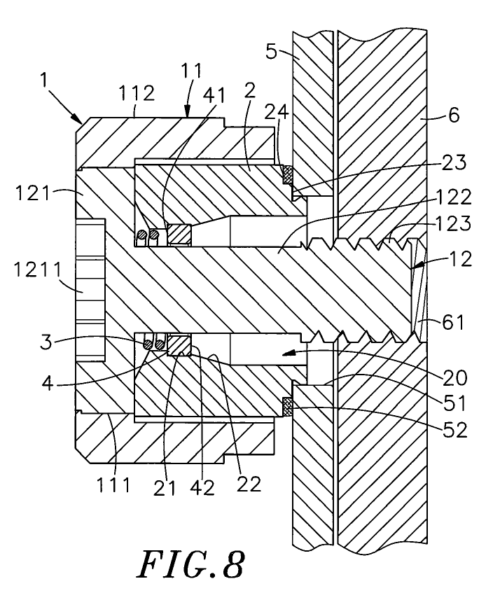

Referring to FIGS. 7 and 8, during application, press-fit the bottom extension tube 23 of the barrel 2 into a mounting through hole 51 of a first metal plate member 5 to attach the bottom bonding wall 24 of the barrel 2 to the solder paste 52 being applied to the border area of the mounting through hole 51 of the first metal plate member 5. Alternatively, an automatic installation machine can be used to pick up the metal plate member fixation device and then to insert the bottom extension tube 23 of the barrel 2 of the metal plate member fixation device into the mounting through hole 51 of the first metal plate member 5 tightly. Thereafter, a reflow soldering process is applied to bond the barrel 2 to the first metal plate 5.

After installation of the barrel 2 in the first metal plate member 5, attach the first metal plate member 5 to a second metal plate member 6 to keep the mounting through hole 51 of the first metal plate member 5 in alignment with one screw hole 61 of the second metal plate member 6, and then force the cap 11 downwards and rotate the grip 112 of the cap 11 to drive the outer thread 123 of the lock screw bolt 12 into the screw hole 61 of the second metal plate member 6, and then attach a hand tool (for example, screwdriver) to the tool groove 1211 of the head 121 of the lock screw bolt 12 and rotate the hand tool to tighten up the connection between the lock screw bolt 12 and the second metal plate member 6. Thus, the first metal plate member 5 and the second metal plate member 6 are locked together. When wishing to dismount the first metal plate member 5 from the second metal plate member 6, rotate the cap 11 in the reversed direction to disengage the thread 123 of the lock screw 12 from the screw hole 61 of the second metal plate member 6, allowing removal of the first metal plate member 5 from the second metal plate member 6.

Further, the stop washer 4 can be made in the form of a flat retaining ring or C-shaped retainer ring. Further, the stop washer 4 is positioned in the annular inside locating groove 21 of the barrel 2, having the top bearing surface 41 thereof stopped against one end of the spring member 3 and the bottom stop surface 42 thereof disposed for stopping against the thread 123 of the lock screw bolt 12 to prohibit escape of the lock screw bolt 12 from the barrel 2. By means of the application of the stop washer 4, the height (length) of the spring member 3 can be minimized so that the metal plate member fixation device can have a low profile characteristic.

A prototype of metal plate member fixation device has been constructed with the features of FIGS. 1˜8. The metal plate member fixation device functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A metal plate member fixation device for fastening to a mounting through hole of a first metal plate member and a screw hole of a second metal plate member to join said first metal plate member and said second metal plate member together, the metal plate member fixation device comprising:
a locking device insertable through the mounting through hole of said first metal plate member and fastenable to the screw hole of said second metal plate to lock said first metal plate to said second metal plate, said locking device comprising a cap, said cap having a center opening, and a lock screw bolt axially mounted in said center opening of said cap, said lock screw bolt comprising a head fixedly fastened to said cap at one end of said center opening of said cap, a shank perpendicularly extended from a bottom wall of said head, a thread spirally extending around the periphery of one end of said shank remote from said head and suspending outside said cap;
a barrel, said barrel comprising a mounting hole extending through top and bottom sides thereof for the passing of the shank of said lock screw bolt and an annular inside locating groove disposed inside the mounting hole near the top side of said barrel;
a spring member received in the center opening of said cap and stopped against the head of said lock screw bolt; and
a stop washer set in the annular inside locating groove of said barrel around the shank of said lock screw bolt, said stop washer having a top wall stopped against one end of said spring member opposite to the head of said lock screw bolt and a bottom wall for stopping against one end of the thread of said lock screw bolt to prohibit escape of said lock screw bolt of said locking device from said barrel.

2. The metal plate member fixation device as claimed in claim 1, wherein said cap of said locking device comprises a grip integrally formed of the periphery thereof for gripping by hand to rotate said locking screw bolt and a mounting groove formed in one end of the center opening thereof; the head of said lock screw bolt is affixed to the mounting groove of said cap, having a tool groove located on a top wall thereof.

3. The metal plate member fixation device as claimed in claim 1, wherein said barrel further comprises a sloping inside wall portion disposed around the mounting hole thereof and gradually increasing in diameter in direction from the annular inside locating groove toward the bottom side thereof.

4. The metal plate member fixation device as claimed in claim 1, wherein said cap is molded on the head of said lock screw bolt by over-molding; said lock screw bolt is a metal screw bolt.

5. The metal plate member fixation device as claimed in claim 1, wherein said lock screw bolt is a metal screw bolt and fixedly fastened with the head thereof to the mounting groove of said cap by an engagement structure.

6. The metal plate member fixation device as claimed in claim 1, wherein said barrel comprises a bottom bonding wall located on the bottom side around the mounting hole thereof for bonding to said first metal plate member around the mounting through hole of said first metal plate member, and a bottom extension tube perpendicularly extended from said bottom bonding wall for insertion into the mounting through hole of said first metal plate member for allowing said lock screw bolt to be threaded into the screw hole of said second metal plate member.

7. The metal plate member fixation device as claimed in claim 6, wherein said bottom bonding wall of said barrel is bonded to said first metal plate member around the mounting through hole of said first metal plate member with a solder paste by means of a reflow soldering process.

8. The metal plate member fixation device as claimed in claim 1, wherein said stop washer is formed of a C-shaped retaining ring.

9. The metal plate member fixation device as claimed in claim 1, wherein said stop washer is formed of a flat retaining ring.

10. The metal plate member fixation device as claimed in claim 1, wherein said stop washer is made from a high extensible metal material selected from one of brass, zinc alloy and aluminum.
